(19) United States
(12) Patent Application Publication
(10) Pub. No.: US 2025/0121241 A1
(43) Pub. Date: Apr. 17, 2025

(54) MERCURY TREATMENT AND ENCAPSULATION PROCESS

(71) Applicant: PERMA-FIX ENVIRONMENTAL SERVICES, INC., Atlanta, GA (US)

(72) Inventors: Richard Devin, Atlanta, GA (US); Louis Centofanti, Atlanta, GA (US)

(21) Appl. No.: 18/903,132

(22) Filed: Oct. 1, 2024

Related U.S. Application Data
(60) Provisional application No. 63/543,623, filed on Oct. 11, 2023.

(51) Int. Cl. A62D 3/38; A62D 101/43; B09B 1/00; B09B 3/20; B09B 3/70

(52) U.S. Cl. CPC A62D 3/38; B09B 1/00; B09B 3/20; B09B 3/70; A62D 2101/43

(57) ABSTRACT

A system and method for disposing non-radioactive mercury found in waste material at a concentration of greater than 260 mg of mercury per kg of the waste material is provided. The method includes a chemical treatment step followed by an encapsulation step. The chemical treatment includes mixing the waste mercury with sulfur in a reactor to convert the mercury into mercury sulfide. The chemical treatment also includes maintaining conditions within the reactor for reaction efficiency and safety. Other additives may be added to the reactor to further mitigate leachability or mobility of the mercury in order to meet a regulatory standard regarding waste mercury. The encapsulation includes placing the chemically treated mercury inside an impervious container, such as a steel, cement, or plastic container. The encapsulated and chemical treated mercury can then be placed in a landfill without an unacceptable risk to human health and the environment.

### CROSS-REFERENCE TO RELATED APPLICATIONS

This U.S. non-provisional patent application claims the benefit of and priority to U.S. provisional patent application Ser. No. 63/543,623, filed Oct. 11, 2023, the entire disclosure of which is hereby incorporated by reference in its entirety.

### BACKGROUND OF THE INVENTION

### 1. Field of the Invention

The invention relates generally to a system and method for disposing of mercury (Hg), and more specifically to a system and method for treating and disposing of non-radioactive mercury recovered from waste at concentrations greater than 260 mg of mercury per kg of waste.

### 2. Related Art

In the past, non-radioactive mercury was used in various products and processes, and thus there was a significant demand for recycled non-radioactive mercury. However, the products and processes that once used mercury have been refined so that a significant market for recycled mercury no longer exists. A large surplus of mercury recovered from waste has been produced, for which there is no path for recycling. In addition, current regulations in the United States governing non-radioactive mercury require recovery and recycling of the mercury if it is present in the waste at a concentration of greater than 260 mg of mercury per kg of the waste. Therefore, it has been proposed that reclaimed mercury be temporarily stored pending development of technologies and regulations to allow for treatment and permanent disposal of the mercury waste.

Concentration-based Environmental Protection Agency (EPA) numerical treatment standards currently exist for waste containing mercury at a concentration of less than 260 mg of mercury per kg of waste. These standards are based on chemical stabilization and immobilization of the mercury in the waste. However, it would be difficult or impossible for chemical treatment alone to meet these same Environmental Protection Agency (EPA) requirements for waste elemental mercury or other waste containing higher levels of mercury.

A special regulatory dispensation has been made in the United States for waste elemental mercury that is contaminated with licensed radioactive material. However, the volume of non-radioactive mercury waste that is generated is much larger than the volume of the radioactively contaminated waste elemental mercury. The impact of simply applying the same treatment standard to this much larger volume of waste would pose too great a risk to human health and the environment.

In summary, there is a need for a practical and safe system and method for permanently disposing of surplus non-radioactive mercury recovered from waste without an unacceptable risk to human health and the environment.

### SUMMARY

A practical and safe system and method for disposing mercury without an unacceptable risk to human health and the environment is provided. The system and method includes chemical treatment followed by encapsulation.

The chemical treatment includes combining the mercury with sulfur to convert the mercury to mercury sulfide. The chemical treatment may include certain conditions and may include combining the mercury with other additives to further mitigate leachability or mobility of the mercury in order to meet required regulations, for example a concentration of less than 0.2 mg of mercury per liter of test solution when tested according to the EPA test method referred to as the Toxicity Characteristic Leaching Procedure (TCLP). The encapsulation includes placing the chemically treated mercury inside an impervious container. The encapsulated and chemically treated mercury can then be placed in a landfill or other type of containment system without an unacceptable risk to human health and the environment.

### DESCRIPTION OF EXAMPLE EMBODIMENTS

One aspect of the disclosure provides a system and method for disposing of mercury without an unacceptable risk to human health and the environment, more specifically a system and method for disposing of non-radioactive mercury recovered from waste. The system and method includes chemical treatment followed by encapsulation.

The chemical treatment step includes placing the waste mercury in a reactor. The waste mercury can include elemental mercury and/or non-debris solids contaminated with elemental and/or non-elemental chemical forms of mercury at concentrations greater than 260 mg of mercury per kg of the waste material. The chemical treatment step includes mixing the waste mercury with elemental sulfur and optionally other reagents to convert the waste mercury into mercury sulfide. Preferably, the chemical treatment includes maintaining conditions within the reactor using heating, cooling, and inert gases for reaction efficiency and safety. Optionally, the chemical step may involve adding other additives to the reactor, for example sequestrants, buffers, binders, or other reagents. The elemental sulfur, other reagents, and possible additional additives mitigate leachability or mobility of the mercury.

According to an example embodiment, the chemical treatment applied to the waste mercury is the chemical treatment process disclosed in U.S. Pat. No. 6,403,044. The chemical treatment process disclosed in the '044 patent uses a reactor to stabilize the elemental and/or non-elemental mercury in non-debris solids. The process involves coating mechanical mixing elements of the reactor with elemental sulfur, mixing in the mercury waste, adding additives (bulking agents) to enhance mixing and control volume, temperature, etc., and finally adding polysulfide to convert the mercury into mercury sulfide.

According to another example embodiment, the chemical treatment applied to the waste mercury is the chemical treatment process disclosed in U.S. Pat. No. 6,911,570. The chemical treatment process disclosed in the '570 patent stabilizes mercury contained in the non-debris solids. The process includes heating, cooling, and vigorous mixing of the non-debris solids in a reactor with a metal reagent and with a sulfur-containing compound (sulfide or polysulfide) in an oxygen depleted environment, to convert the mercury into mercury sulfide.

After the chemical treatment process, the chemically treated mercury-containing product preferably meets the EPA standard for “non-hazardous waste” for the purpose of disposal when tested according to the Toxicity Characteristic Leaching Procedure (TCLP). The TCLP test measures the potential for the mercury to seep or leach into groundwater from waste potentially disposed in a landfill. The test includes mixing the mercury or mercury-containing material with an acidic solution. The acidic solution is then filtered from the mercury or mercury-containing material. The mercury-containing material is considered “non-hazardous” if less than 0.2 mg of mercury is found per liter of acidic test solution.

According to another example embodiment, when the chemical treatment is applied to elemental mercury having a purity of greater than 95%, the chemical treatment step is conducted according to 40 CFR § 268.42 titled Treatment standards express as specific technologies, and specifically the AMLGM standard. This standard is typically applied to radioactive mercury. According to another example embodiment, when the chemical treatment is applied to elemental mercury having a purity of greater than 95%, the chemical treatment step includes forming mercury sulfide (metacinnabar) and supplemental stabilization, with leachate testing to confirm that the content of mercury is non-hazardous. When the chemical treatment is applied to elemental mercury having a purity of greater than 95%, the chemical treatment step can alternatively include other steps which meet a uniform numerical-based treatment standard or which meet a land disposal cell numerical-based treatment standard of 0.2 mg of mercury per liter of test solution using disposal cell leachate properties and contact scenario, or other leaching protocol.

According to another example embodiment, the chemical treatment is applied to elemental mercury contaminated substances or mixtures including greater than 260 mg of mercury per kg of the substance or mixture and having a purity of less than 95%. In this case, the chemical treatment step can include forming mercury sulfide (metacinnabar) and supplemental stabilization, with leachate testing to confirm that the content of mercury is non-hazardous. Alternatively, the method can include a chemical treatment step which meets a uniform numerical-based treatment standard or which meets a land disposal cell numerical-based treatment standard of XY mg of mercury per liter of test solution using disposal cell leachate properties and contact scenario, or other leaching protocol.

After the chemical treatment step, the system and method of the present disclosure includes the encapsulation of the chemically treated mercury-containing product. The encapsulation step involves placing one or more batches of the chemically stabilized waste mercury inside a container. The container could be a bag, box, drum or other container which isolates the chemically treated mercury from the environment and exposure in a landfill that might eventually result in the mobilization and potential release of mercury that has been otherwise stabilized. The container is formed of an impervious material, for example a container formed of polymer, plastic, steel, or cement. According to certain embodiments, the container may include numerous layers of the impervious material. The encapsulation could also be macroencapsulation. For example, the chemically treated mercury could be placed in a macro bag.

The container encapsulating the chemically treated waste mercury can be buried in a properly constructed landfill or other containment system. The container should adequately protect human health and the environment from harmful amounts of mercury. Preferably, the container encapsulating the chemically treated waste mercury has a projected useful life of at least 5000 years.

According to an example embodiment, the encapsulation step is conduced according to 40 CFR § 268.42, titled Treatment standards expressed as specified technologies, and specifically the MACRO standard. According to another embodiment, the encapsulation step can be conducted by a customized technology-based treatment standard of MACRO that stipulates the acceptable types of encapsulation (e.g., multi-layer plastics in a bag configuration). According to yet another embodiment, the encapsulation can be conducted along with the chemical treatment step to achieve a minimum migration potential of a certain number of years. This technique may need to take into consideration the land disposal cell leaching conditions.

It is believed that the United States Environmental Protection Agency (EPA) would approve the system and method disclosed herein, including the chemical treatment and encapsulation, as an acceptable and safe procedure for disposing of non-radioactive mercury in a landfill.

Obviously, many modifications and variations of the present invention are possible in light of the above teachings and may be practiced otherwise than as specifically described while within the scope of the following disclosure and claims.

1. A method for disposing mercury, comprising the steps of:
chemically treating the mercury by combining the mercury with sulfur to form mercury sulfide; and
encapsulating the chemically treated mercury by placing the chemically treated mercury in a container.

2. The method of claim 1 including burying the encapsulated and chemically treated mercury in a landfill.

3. The method of claim 1, wherein the chemically treated mercury has a concentration of less than 0.2 mg of mercury per liter of test solution when tested according to the EPA test method referred to as the Toxicity Characteristic Leaching Procedure (TCLP).

4. The method of claim 1, wherein the mercury is non-radioactive and recovered from waste material, and the concentration of the mercury is greater than 260 mg of mercury per kg of the waste material.

5. The method of claim 1, wherein the container is formed of an impervious material.

6. The method of claim 5, wherein the impervious material is steel, cement, or plastic.

7. The method of claim 5, wherein the container is a bag, box, or drum.

8. The method of claim 5, wherein the container has a projected useful life of at least 5000 years.

9. The method of claim 1, wherein the mercury is provided in the form of elemental mercury.

10. The method of claim 9, wherein the elemental mercury has a purity of at least 95%.

11. The method of claim 1, wherein the mercury is present in a waste material at a concentration of greater than 260 mg of mercury per kg of the waste material.

12. The method of claim 1, wherein the step of chemically treating the mercury includes mixing the mercury and the sulfur with at least one additive.

13. The method of claim 12, wherein the at least one additive includes a reagent, a sequestrant, a buffer, bulking agent, and/or a binder.

14. The method of claim 1, wherein the step of chemically treating the mercury includes heating or cooling the mercury and sulfur.

15. The method of claim 1, wherein the step of chemically treating the mercury includes occurs in a reactor.

16. The method of claim 15 including providing an inert gas in the reactor.

17. The method of claim 15 including coating mechanical mixing elements present in the reactor with the sulfur, the sulfur being in the form of elemental sulfur, mixing the mercury with at least one additive with the mechanical mixing elements, and adding polysulfide to the reactor.

18. The method of claim 15 including mixing the mercury and the sulfur with a reagent containing metal, and the sulfur being in the form of sulfide or polysulfide.

19. The method of claim 18, wherein the reactor contains an oxygen depleted environment.

20. A system for disposing mercury according to the method of claim 1 including a reactor for the chemical treatment.
